(19) United States
(12) Patent Application Publication
(10) Pub. No.: US 2009/0138270 A1
(43) Pub. Date: May 28, 2009

(54) PROVIDING SPEECH THERAPY BY QUANTIFYING PRONUNCIATION ACCURACY OF SPEECH SIGNALS

(75) Inventors: Samuel G. Fletcher, Springville, UT (US); Dah-Jye Lee, American Fork, UT (US); Jared Darrell Turpin, Bosie, ID (US)

Correspondence Address: MESCHKOW & GRESHAM, P.L.C., 5727 NORTH SEVENTH STREET, SUITE 409, PHOENIX, AZ, 85014, US

(73) Assignee: Samuel G. Fletcher, Springville, UT (US)

(21) Appl. No.: 11/944,844

(22) Filed: Nov. 26, 2007

(51) Int. Cl. G10L 21/06

(52) U.S. Cl. 704/271; 704/E21.02

(57) ABSTRACT

The provision of speech therapy to a learner (76) entails receiving a speech signal (156) from the learner (76) at a computing system (24). The speech signal (156) corresponds to an utterance (116) made by the learner (76). A set of parameters (166) is ascertained from the speech signal (156). The parameters (166) represent a contact pattern (52) between a tongue and palate of the learner (156) during the utterance (116). For each parameter in the set of parameters (166), a deviation measure (188) is calculated relative to a corresponding parameter from a set of normative parameters (138) characterizing an ideal pronunciation of the utterance (116). An accuracy score (56) for the utterance (116), relative to its ideal pronunciation, is generated from the deviation measure (188). The accuracy score (56) is provided to the learner (76) to visualize accuracy of the utterance (116) relative to its ideal pronunciation.

### TECHNICAL FIELD OF THE INVENTION

The present invention relates to the field of speech therapy. More specifically, the present invention relates to speech analysis, visualization feedback, and pronunciation accuracy quantification methodology for the hearing and/or speech impaired and in new language sound learning.

### BACKGROUND OF THE INVENTION

Speech can be described as an act of producing sounds using vibrations at the vocal folds, resonances generated as sounds traverse the vocal tract, and articulation to mold the phonetic stream into phonic gestures that result in vowels and consonants in different words. Speech is usually perceived through hearing and learned through trial and error repetition of sounds and words that belong to the speaker's native language. Second language learning can be more difficult because sounds from the native language can inhibit new sound mastery of the second language.

By definition, hearing impaired individuals are those persons with any degree of hearing loss that has an impact on their activities of daily living or who require special assistance or intervention due to the inability to hear the speech related sound frequencies and intensities. The term “deaf” refers to a person who has a permanent and profound loss of hearing in both ears and an auditory threshold of more than ninety decibels. The task of learning to speak can be difficult for any person with impaired hearing, and extremely difficult for the deaf. For example, deaf persons may undergo speech therapy that entails watching the teacher's lips and using glimpses of tongue movements to arrive at recognizable sounds then try to use these sounds in real life vocal communication settings. This repetitive, trial and error, procedure is time consuming, too often unsuccessful, tedious, and frustrating to both the learner and the teacher. In addition, the resulting still limited vocal skills are reflected in the typical high school deaf graduate by difficult-to-understand speech and in reading at a fourth grade level.

For centuries both scientific and applied efforts to understand and teach vocal communication functions have been heavily dependent upon auditory impressions, acoustic feedback, subjective observations, and perceptual ratings. Indeed, early methods of in vivo speech investigation were restricted to what could be seen (e.g., movement of the lips and jaw), felt (e.g., vibration of the larynx, gross tongue position), or learned from introspection of articulator positions during speech production.

X-ray was discovered in the late 1800s and adopted shortly thereafter for use in phonetically related studies and experiments. Indirect, or cinefluorographic x-ray motion observation, emerged shortly thereafter. Studies followed using this technology to document phonetic postures and extend the analysis of movement during sound production. X-ray technology was, however, fraught with problems most importantly being the damaging radiation inherent in radiographic procedures. Computerized x-ray systems were subsequently introduced to reduce radiation, but their use was mostly limited to tracking movements of a small number of pellets glued to the tongue surface. This instrumentation was also too bulky and costly for use outside the speech science laboratory.

Attempts to translate actions into visual patterns led to emergence of the sound spectrograph that converts sound waves into visual displays of the sound spectrum. The sound spectrum can then be shown on an oscilloscope, cathode ray tube, or a like instrument. Through the use of visual feedback techniques provided by the spectrograph, the sound spectrograph became a powerful speech science tool, and attempts were made to enhance conventional speech using the sound spectrograph. However use of the sound spectrograph as a clinical tool has been limited. The displays are too complex for most people to learn quickly, and they don't expose the physical details of the signals displayed.

Discovery of magnetic resonance imaging (MRI) led to the ability to examine the tongue surface through magnetic gradient manipulation. Unfortunately, the examinee was required to be in a supine position and the cost for the equipment, data collection expenses, equipment noise, and a slow sampling rate discouraged its use outside of the science laboratory. MRI instrumentation developed more recently reduces some of these limitations, but is still not feasible for daily clinical usage.

Other devices, such as aerodynamic, electromyographic, magnetic resonance imaging, and ultrasound processing instruments introduced from time to time to examine functions of the phonetic system in various ways are now also in the public domain, but the emerging conclusion has been that less costly, more portable instrumentation that could enable fine detailed phonetic observations and modification of abnormality was still needed for clinicians, most of whom are practicing outside the science laboratories. The specific need for instrumentation to examine and modify phonetic gestures at a practical level for clinical assessment and remediation has still been lacking.

Devices, such as the electronic palatograph developed in the mid-nineteen hundreds, provides more rigorous assessment of speech articulation, but have been stymied by speaker-to-speaker variations in contact sensing locations and by an inability to translate phonetic data into standardized measures and quantitative descriptions of speech similarities and variations in order to define phonetic gesture normality and abnormailty accurately.

Development of the palatometer partially overcame the limitations of prior art electronic palatographs. The palatometer includes a mouthpiece contained in the user's mouth. The mouthpiece resembles an orthodontic retainer having numerous sensors mounted thereon. The sensors are connected via a thin strip of wires to a box which collects and sends data to a computer. The computer's screen displays two pictures—one of a simulated mouth of a “normal speaker” and one of a simulated mouth in which the locations of the sensors are represented as dots. As the user pronounces a sound, the tongue touches specific sensors, which causes corresponding dots to light up on the simulated mouth displayed on the computer. The user may learn to speak by reproducing on the simulated mouth the patterns presented on the display of the “normal speaker.”

Rapid and substantial gains in phonetic skills have been attained when the palatometer was used with hearing and speech handicapped individuals. However, while the palatometer has laid the foundation for precise phonetic measurements, it suffers from an inability to provide quantitative, easily understood feedback to a learner as to the accuracy of speech pronunciation.

### SUMMARY OF THE INVENTION

Accordingly, it is an advantage of the present invention that a method of providing speech therapy using a computing system executing voice analysis and visualization code is provided.

It is another advantage of the present invention that that the methodology and code provide visualization of speech signals and quantification of an accuracy of speech pronunciation.

Yet another advantage of the present invention is that a method and code are provided that display a numerical score of the accuracy of a learner's speech.

The above and other advantages of the present invention are carried out in one form by a method for providing speech therapy to a learner. The method calls for receiving a speech signal from the learner at an input of a computing system, the speech signal corresponding to a designated utterance made by the learner. A set of parameters representing a contact pattern between a tongue and a palate of the learner during the utterance is ascertained from the speech signal. For each parameter of the set of parameters, a deviation measure is calculated relative to a corresponding parameter from a set of normative parameters characterizing an ideal pronunciation of the utterance. The set of normative parameters represents a contact template between a model tongue and a model palate. An accuracy score for the designated utterance relative to the ideal pronunciation of the utterance is generated from the deviation measure. The accuracy score is provided to the learner to visualize an accuracy of the utterance relative to the ideal pronunciation of the utterance.

The above and other advantages of the present invention are carried out in another form by a system for providing speech therapy to a learner. The system includes a sensor plate positioned against a palate of the learner, the sensor plate including a plurality of sensors disposed on the sensor plate. Each of the sensors produces a contact indication signal of the tongue of the learner to each of the sensors during a designated utterance made by the learner. The system further includes a processor having an input in communication with the sensor plate for receiving a speech signal from the learner corresponding to the designated utterance. The processor performs operations that include ascertaining from the speech signal, the contact indication signal from each of the sensors and for each contact indication signal, calculating a deviation measure relative to a corresponding normative contact indication signal from a set of normative parameters characterizing an ideal pronunciation of the utterance. The processor generates from the deviation measure an accuracy score for the designated utterance relative to the ideal pronunciation of the utterance. A display is in communication with the processor for providing the accuracy score to the learner to visualize an accuracy of the utterance relative to the ideal pronunciation of the utterance.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a perspective view of a system that may be used for speech therapy and feedback visualization in accordance with the present invention;

FIG. 2 shows a plan view of a flexible printed circuit used in the system of FIG. 1;

FIG. 3 shows a block diagram of the system of FIG. 1 with a sensor plate of FIG. 1 being installed in the mouth of a learner;

FIG. 4 shows a flowchart of a contact template generation process in accordance with the present invention;

FIG. 5 shows a table of exemplary sets of normative contact indication signals compiled in response to the execution of the contact template generation process of FIG. 4;

FIG. 6 shows a table of a portion of a contact template database of the present invention;

FIG. 7 shows a flowchart of a speech therapy process in accordance with the present invention;

FIG. 8 shows a table of computations utilized within the process of FIG. 7; and

FIG. 9 shows an illustration of a display of computing system.

### DETAILED DESCRIPTION OF THE PREFERRED EMBODIMENTS

The present invention entails a method, executable code, and system for speech therapy and visualization that includes providing a numerical score of the accuracy of pronunciation of speech by a learner.

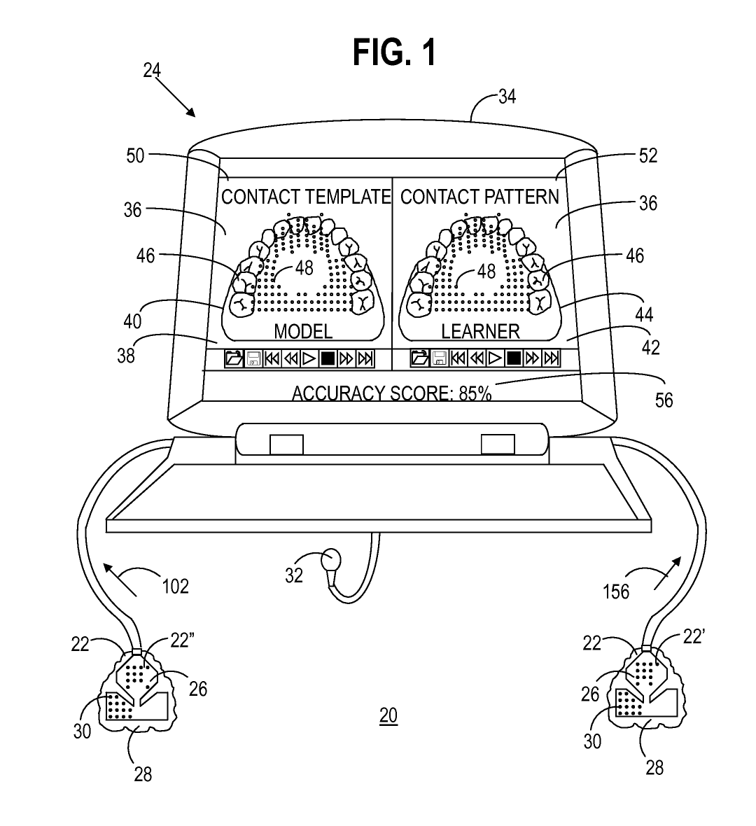

FIG. 1 shows a perspective view of a system 20 that may be used for speech therapy and feedback visualization. System 20, sometimes referred to as a palatometer, makes use of linguapalatal (tongue-to-palate) contact information received from a normal speaking model and from a learner seeking to imitate the model.

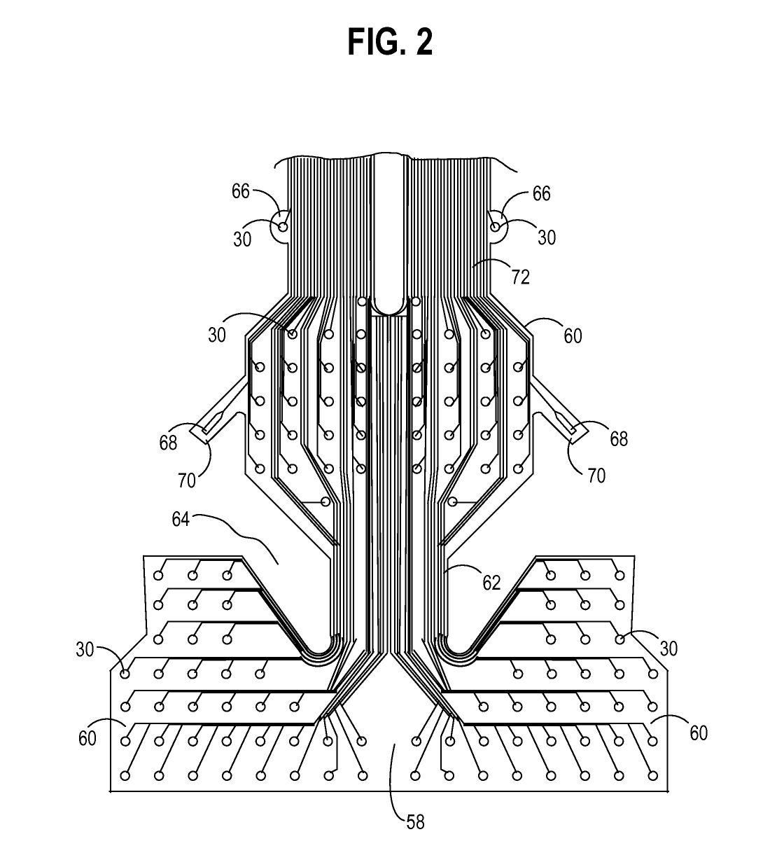

System 20 includes a sensor plate 22, sometimes referred to as a pseudo palate, connected to a computing system 24 that serves as signal processing and display equipment. Sensor plate 22 includes a flexible printed circuit 26, described in detail in connection with FIG. 2, mounted on a baseplate 28. Flexible printed circuit 26 includes contact sensing electrodes, referred to herein as sensors 30, distributed across its surface in a grid array. Baseplate 28 may be formed of soft plastic material to fit a user's palate and teeth configuration.

System 20 is shown with two sensor plates 22. One of sensor plates 22, designated 22′, is custom fit and worn by a learner during speech therapy. The other sensor plate 22, designated 22″, represents any number of custom fit sensor plates 22 worn by models during data collection of normative speech signals that may occur prior to a learner's speech therapy. Accordingly, when system 20 is utilized during speech therapy, only one sensor plate 22, i.e., learner's sensor plate 22′, may be connected to computing system 24.

The terms “model,” “model speaker,” and their plurals utilized herein refer to one or more individuals who are normal speakers, i.e., those who do not suffer from any speech or hearing impediments. One or more models may be utilized from which normative speech signals are obtained and assessed. These normative speech signals can then be compared with a learner's imitations of the same speech signals to determine and document a “closeness of phonetic imitation,” that is, to determine an accuracy of pronunciation of a particular sound.

In one embodiment, computing system 24 may also include a microphone 32 for collecting a learner's audible utterances or speech for later processing. In addition, computing system 24 includes a display 34 configured as a split screen 36 so that two representations can be shown concurrently. For example, a first section 38 of split screen 36 may include a representation of a model mouth 40, and a second section 42 of split screen 36 may include a representation of a learner mouth 44. Each of model mouth 40 and learner mouth 44 includes dental landmarks 46, such as images of teeth, the palate, and the like. Dental landmarks 46 are represented as though an observer is looking upward from the tongue. Dental landmarks 46 thus serve as natural orienting landmarks to help an observer focus on how, when, and where articulation actions transpire in the mouth as different sounds are modeled and articulated.

Each of model mouth 40 and learner mouth 44 are overlaid by a grid of dots 48. Each of dots 48 represents a corresponding one of sensors 30, and the location of each of dots 48 overlying model mouth 40 and learner mouth 44 portrays the location of the corresponding one of sensors 30 within the mouth of the model and the learner.

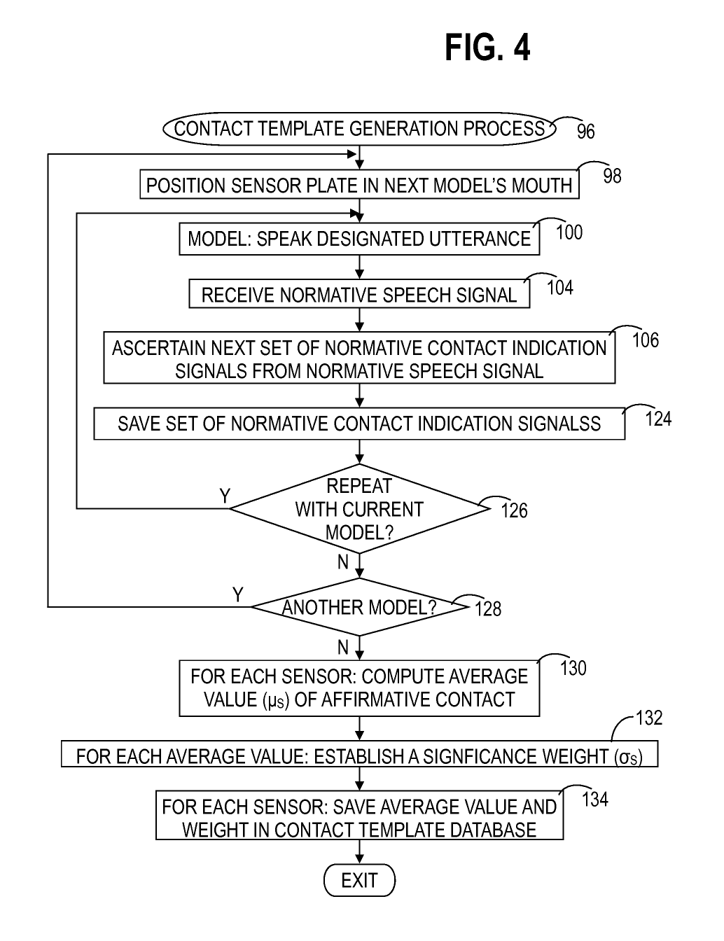

Dots 48 overlying model mouth 40 change color, enlarge, illuminate, or otherwise become distinguishable from the remaining dots 48 in response to an “ideal” or “normal” pronunciation of a particular sound. These distinguished dots 48 overlying model mouth 40 represent an ideal linguapalatal (tongue-to-palate) placement, or a contact template 50, of a speaker uttering a particular sound. The generation of contact template 50 will be discussed below in connection with FIG. 4.

When sensors 30 are actually contacted by the learner's tongue during a particular utterance by the learner, the corresponding dots 48 overlying learner mouth 44 also change color, enlarge, illuminate, or otherwise become distinguishable from the remaining dots 48. The distinguished dots 48 shown on learner mouth 44 represent an actual linguapalatal placement, or a contact pattern 52, of the tongue of the learner uttering a particular sound. Contact pattern 52 on learner mouth 44 can be compared with contact template 50 on model mouth 40 to provide visual feedback regarding the learner's tongue placement and corresponding accuracy of pronunciation of a particular sound or utterance.

Human learning typically starts with mimicking or echoing back actions performed by others. System 20 leverages this learning strategy by providing contact pattern 52 concurrent with contact template 50. A learner's visualization of the closeness of contact pattern 52 to contact template 50 can be a highly useful factor in phonetic modification. In order to further enhance this learning strategy, an accuracy score 56 is also presented within display 34.

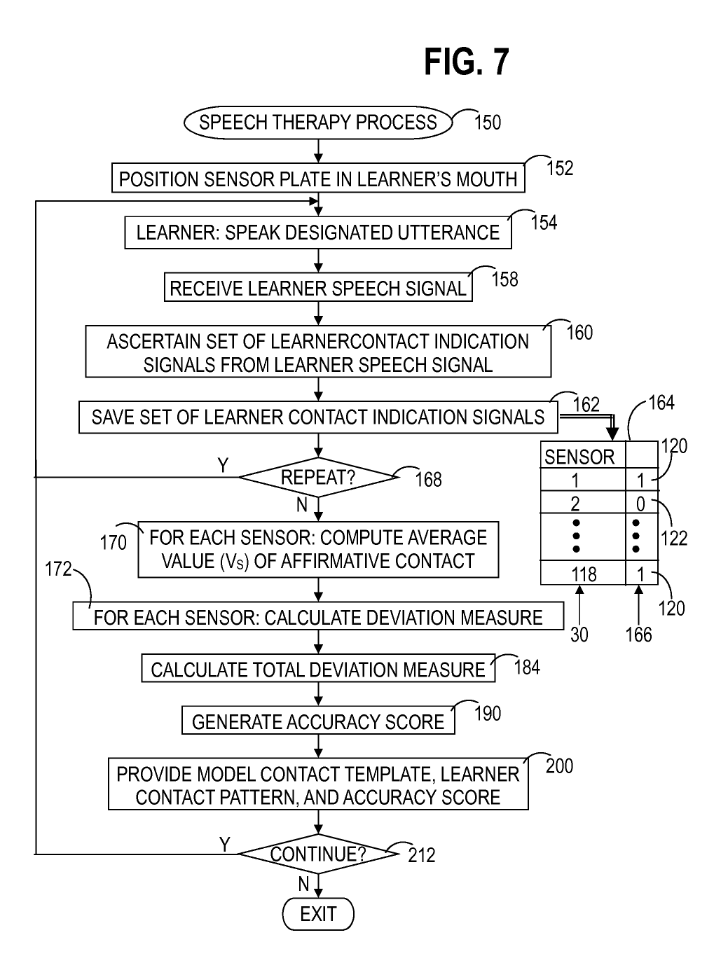

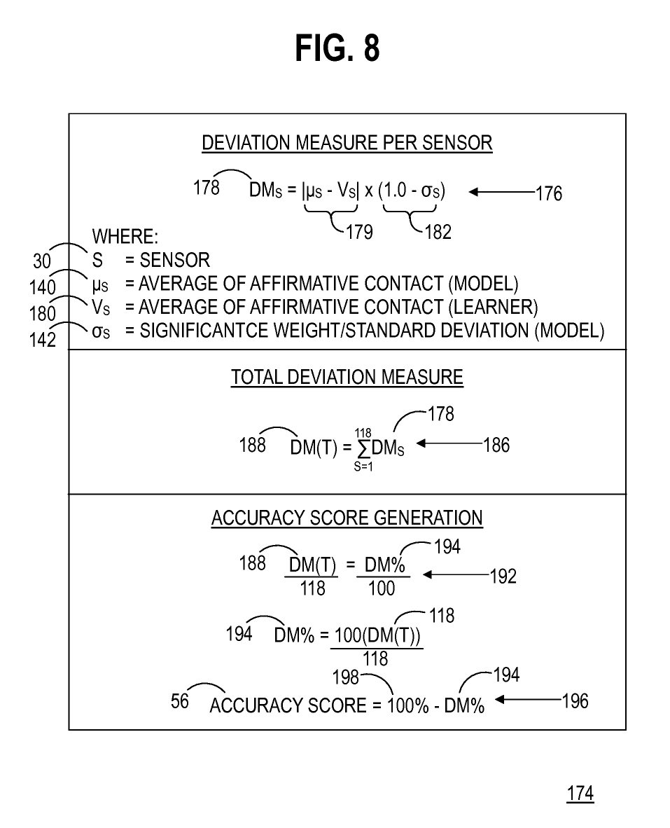

In accordance with the present invention, accuracy score 56 provides an accurate quantification of a learner's accuracy of pronunciation of a sound, visually represented by contact pattern 52, relative to a model speaker's pronunciation of the same sound, visually represented by contact template 50. Accuracy score 56 provides quantification of the differences of contact sensors 30 relative to ideal sensor contact represented in contact template 50. Accuracy score 56 can be represented as a percentage of imitation accuracy that is readily understood by a learner. For example, accuracy score 56 can be used to advise the learner how closely his/her imitation matches contact template 50 and to identify changes in imitation accuracy as the learner progresses toward normal phonetic behavior. The calculation of accuracy score 56 is discussed below in connection with FIGS. 7-8.

FIG. 2 shows a plan view of flexible printed circuit 26 used in sensor plate 22 (FIG. 1) of system 20 (FIG. 1). FIG. 2 shows sensing electrodes 30 distributed across a lingual surface 58 surface of flexible printed circuit 26 in a grid array. Preferably, flexible printed circuit 26 is manufactured initially as a thin flat plate with multiple lobes 60 intercoupled by a thin isthmus 62. This configuration allows flexible printed circuit 26 to be adhered to baseplate 28 (FIG. 1). Spaces 64 between lobes 60 may be varied to allow flexible printed circuit 26 to fit the curvature of baseplate 28 and at the same time retain the desired distance between sensors 30. The shape and flexibility of flexible printed circuit 26 allows sensor plate 22 (FIG. 1) to fit the palates of users of different sizes. Sensor plate 22 is thus constructed to be thin to allow a user to comfortably speak when sensor plate 22 is installed against the user's palate. Flexible printed circuit 26 also preferably has labial sensors 66 located on sensor plate 22 so as to reside between the incisor teeth and lips of the user when installed. Labial sensors 66 largely serve the same function as the remaining sensors 30. Thus, all sensors 30 and 66 will be globally referred to herein as sensors 30.

Contact points 68 on circuit 26 are used to provide a constant electrical path to ground. Contact points 68 may be located on tabs 70 which may be folded and configured such that they are located on the opposite side of baseplate 28 (FIG. 1) from sensors 30. Leads 72, containing conductors which are electrically connected to each of sensors 30, are attachable via a conventional connector (not shown) to computing system 24.

One configuration of flexible printed circuit 26, that includes one hundred and eighteen sensors 30 including the two labial sensors, is shown herein for purposes of explanation. However, it should be understood that other printed circuits for use with a mouth worn sensor plate may include fewer or more sensing electrodes, and/or the printed circuit may be provided in a different shape then that shown.

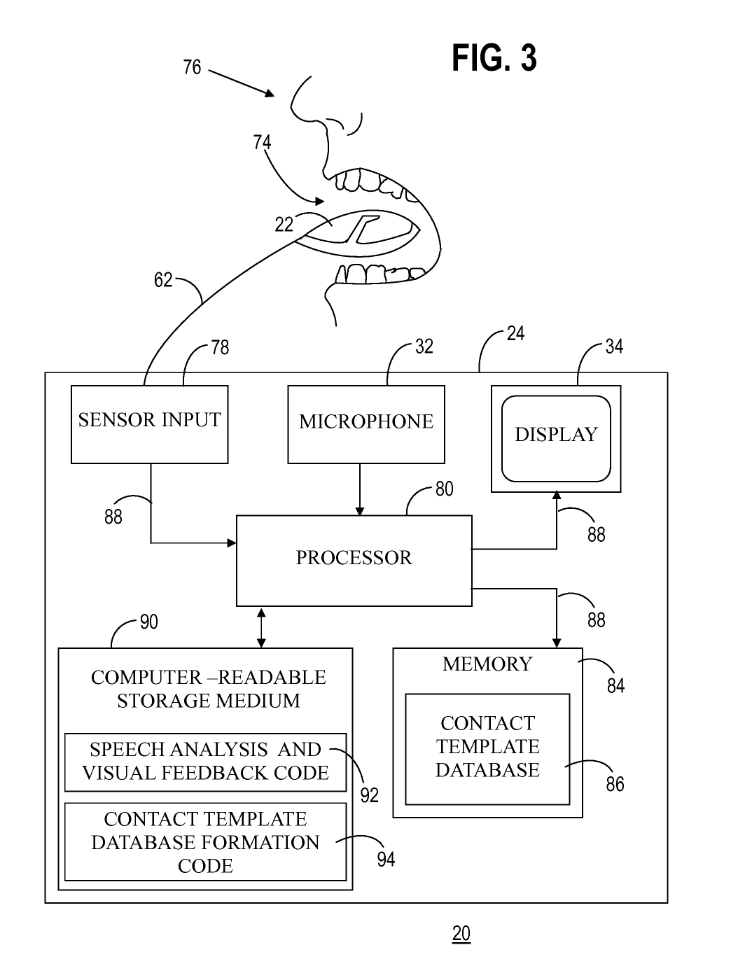

FIG. 3 shows a block diagram of system 20 with sensor plate 22 being installed in the mouth 74 of a learner 76. As shown, sensor plate 22 is connected to a sensor input 78 of computing system 24. Computing system 24 further includes a processor 80 on which the methods according to the invention can be practiced. Processor 80 is in communication with sensor input 78, microphone 32, display 34, and a memory 84 for storing data files in the form of a contact template database 86. These elements are interconnected by a bus structure 88. Other components of a conventional computing system may also form part of system 24 such as a keyboard, mouse, pointing device, and the like for user-provided input to processor 80. Computing system 24 can also include network connections, modems, or other devices used for communications with other computer systems or devices.

Computing system 24 further includes a computer-readable storage medium 90. Computer-readable storage medium 90 may be a magnetic disk, compact disk, or any other volatile or non-volatile mass storage system readable by processor 80. Speech analysis and visual feedback code 92 is executable code recorded on computer-readable storage medium 90 for instructing processor 80 to analyze a speech signal (discussed below) and subsequently present the results of the analysis on display 34 for visualization by learner 76.

In addition, contact template database formation code 94 may optionally be recorded as executable code on computer-readable storage medium 90. Contact template database formation code 94 may be utilized to collect data and generate contact template database 86 prior to utilizing computing system 24 for speech therapy and feedback visualization. Provision of code 94 allows a teacher, therapist, and the like to generate contact template database 86 in accordance with a local dialect or language. However, it should be understood that code 94 need not be provided on computer-readable storage medium 90. Rather, a computer program product in accordance with the present invention may be provided to a teacher, therapist, and so forth that only includes speech analysis and visual feedback process 92 and contact template database 86, with database 86 having been generated previously on a different computing system.

FIG. 4 shows a flowchart of a contact template generation process 96 for creating contact template database 86 (FIG. 3). Process 96 is performed in connection with the execution of contact template database formation code 94 (FIG. 3). As mentioned above, process 96 may be performed utilizing computing system 24 (FIG. 3) and/or on an independent computing system.

Contact template generation process 96 begins with a task 98. At task 98, a next model, i.e., a normal speaker, is selected, and the model's custom-fit sensor plate 22″ (FIG. 1) is positioned against the palate of the model. Contact template database 86 may be created utilizing one or more normal speakers, i.e., those who do not suffer from speech or hearing impediments. Thus, during a first iteration of process 96, the “next” model speaker will be a first model speaker.

Following task 98, the model speaker is instructed to speak a designated utterance, or phonetic gesture, at a task 100. The utterance may be a sound, word, phrase or sentence. When the utterance is a word, phrase, or sentence, the particular sound for which a contact template is to be created will be contained in the word, phrase, or sentence. An utterance made by the model speaker is detected by sensors 30 (FIG. 2) of sensor plate 22″ as a normative speech signal 102 (see FIG. 1). Normative speech signal 102 includes parameters identifying which of sensors 30 are contacted during the utterance made by the model speaker.

In response to task 98, a task 104 is performed. At task 104, normative speech signal 102 is routed to computing system 24 (FIG. 3) where it is received at sensor input 78 (FIG. 3).

Following task 104, a task 106 is performed. At task 106, processor 80 ascertains a next set of normative contact indication signals from normative speech signal 102. Of course, during a first iteration of task 106, the “next” set of normative contact indication signals will be a first set.

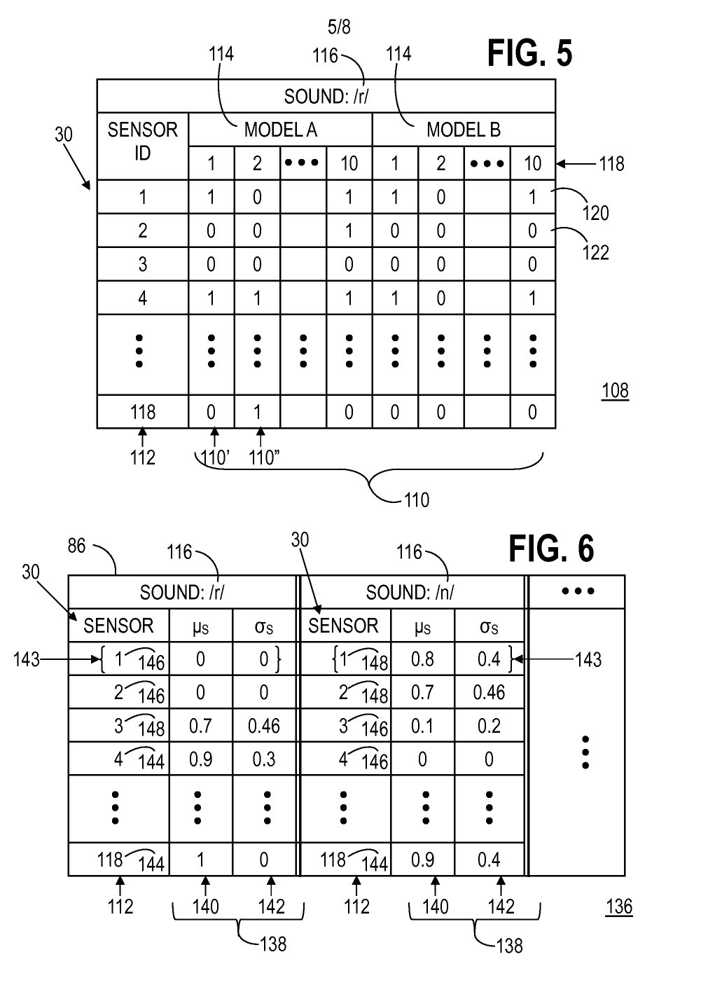

Referring to FIG. 5 in connection with FIG. 4, FIG. 5 shows a table 108 of exemplary sets of normative contact indication signals 110 compiled in response to the execution of contact template generation process 96. Table 108 includes a partial listing of sensors 30 of sensor plate 22 distinguished by unique sensor identifiers 112. Only a few of sensors 30 are listed in table 108 for brevity. The remainder of sensors 30 is represented by ellipses. Table 108 may be compiled for a number of model speakers, of which two model speakers are shown, each of whom is distinguished by model identifiers 114. Each model speaker 114 may repeat a designated utterance 116 which includes, for example, sound/r/over a number of repetitions, distinguished by repetition identifiers 118. For brevity, only a few repetitions of designated utterance 116 are listed in table 108 for each of model speakers 114. The remainder of repetitions is represented by ellipses.

In an exemplary scenario, during a first iteration of process 96, a first model speaker 114, “MODEL A” speaks the designated utterance 116. In one embodiment, sensors 30 produce a signal, such as a voltage, when they are contacted by the model speaker's tongue, and sensors 30 do not produce a signal when they are not contacted by the model speaker's tongue. Thus, sensors 30 are either “on” or “off”, or “true” or “false.” This output of sensors 30, i.e., either a signal or absence of a signal, is referred to herein as a normative contact indication signal. The normative contact indication signal may thus be an affirmative contact signal 120, designated by the numeral “1” herein, indicating that an associated one of sensors 30 was contacted. Alternatively, the normative contact indication signal may be a negative contact signal 122, designated by the numeral “0” herein, indicating that an associated one of sensors 30 was not contacted.

With continued reference to FIGS. 4-5, a task 124 is performed in conjunction with task 106. At task 124, the current set of normative contact indication signals 110, e.g., a first set 110′, is at least temporarily saved in, for example, a memory component corresponding with table 108.

Following task 124, a query task 126 determines whether designated utterance 116 is to be repeated by the current model speaker. When the current model speaker is to repeat pronunciation of designated utterance 116, process control loops back to task 100 so that the model repeats designated utterance and another set of normative contact indication signals 110, e.g., a second set 110″ is ascertained and saved. However, when a determination is made at query task 126 that enough sets of normative contact indication parameters 110 from the current model have been compiled, contact template generation process 96 continues with a query task 128.

At query task 128, a determination is made as to whether another model speaker 114 is to be utilized to collect sets of normative contact indication signals 110. When normative speech signal 102 (FIG. 1) is to be collected from another model speaker 114, e.g., “MODEL B”, process 96 loops back to task 98 for subsequent positioning of that model's custom-fit sensor plate 22″ (FIG. 1) against the palate of the model, speaking designated utterance 116, and compilation of sets of normative contact indication signals 110. When there are no other model speakers 114 for which normative speech signal 102 is to be collected, process 96 continues with a task 130.

Following the above described tasks, sets of normative contact indication signals 110 (FIG. 5) are compiled from one or more model speakers 114. The subsequent tasks of process 92 manage the sets of normative contact indication signals 110 to produce a contact template 50 (FIG. 1) corresponding to an ideal pronunciation of designated utterance 116.

At task 130, an average value, μₛ, of affirmative contact is computed for each of sensors 30. Referring again briefly to FIG. 5, for each sensor 30, the arithmetic mean, or the sum of occurrences of affirmative contact signal 120 divided by the total quantity of repetitions, i.e. total quantity of sets of normative contact indication signals 110, is computed. Thus, the average value, μₛ, of affirmative contact for each of sensors 30 indicates the point on a scale of measures where the quantity of affirmative contact signal 120 is centered.

A task 132 is performed in cooperation with task 130. At task 132, a significance weight for each average value is established. In a preferred embodiment, the significance weight is a standard deviation, σ. As known to those skilled in the art, the standard deviation, σ, is a parameter that indicates the way in which a probability function or a probability density function is centered around its mean. The standard deviation, σₛ, may be computed for each average value, σₛ, as the square root of the variance.

In response to the execution of tasks 130 and 132, a task 134 is performed. At task 134, the average value, μₛ, of affirmative contact, and its standard deviation, σₛ, for each of sensors 30 is saved as a contact template (discussed below) in contact template database 86. Following task 134, contact template generation process 96 exits. Contact template 50 (FIG. 1) is formed for a particular designated utterance 116 (FIG. 5). Contact template 50 is thus a mathematical model for each of sensors 30 specific to a particular designated utterance 116. The execution of process 96 may be repeated to form a number of contact templates 50, each of which is specific to a particular designated utterance 116. Once the mathematical model (contact template 50) for each of sensors 30 for each specific designated utterance is established from a sizable number of model speakers, a standardized percentage accuracy score 56 (FIG. 1) can be generated, as discussed in detail in connection with FIGS. 7-8.

FIG. 6 shows a table 136 of a portion of contact template database 86 of the present invention created through the execution of contact template generation process 96 (FIG. 4). Table 136 includes a set of normative parameters 138 for each of two designated utterances 116. For simplicity, only two sets of normative parameters 138 for two designated utterances 116 are shown in table 136. However, contact template database 86 can include multiple sets of normative parameters 138 for a variety of utterances 116, as represented by ellipses.

Table 136 includes a listing of sensors 30, uniquely identified by sensor identifiers 112. Each set of normative parameters 138 includes a normative average value, μₛ, 140 and its standard deviation, ρₛ, 142 for each of sensors 30. Accordingly, each row, designated by closed brackets 143, of table 136 corresponds to one of sensors 30, its normative average value 140 and its standard deviation 142 for a particular utterance 116.

As previously discussed, normative average value, ρₛ, 140 and its standard deviation, σₛ, 142 for each of sensors 30 were computed through the execution of tasks 130 and 132 of contact template generation process 96 (FIG. 4). Each set of normative parameters 138, provided as a listing of normative average values 140 and standard deviations 142 per sensor 30, represents contact template 50, and provides the necessary information for the subsequent display of contact template 50, discussed below. It should be noted that only a portion of sensors 30 and their associated normative average value 140 and standard deviation 142 are shown in table 136 for simplicity of illustration. The remainder of sensors 30 and their associated normative average values 140 and standard deviations 142 are represented in table 136 by ellipses.

Table 136 may include additional information specific to each set of normative parameters 138 for each contact template 50. This additional information can include the number of samples used in creation of each contact template, the number of distinct files used to create contact template, and the like.

With continued reference to table 136, the closer one of normative average values 140 is to 1 or 0, the more bearing it will have on accuracy score 56 (FIG. 1). A very high normative average value 140, for example, a value 140 between 0.9 and 1, indicates that the associated one of sensors 30 is contacted all or most of the time during the ideal pronunciation of designated utterance 116. Sensors 30 having high normative average values 140 and/or low standard deviations 142 are referred to herein as critical contact sensors 144. Critical contact sensors 144 are those sensors 30 in which contact with these sensors 144 is critical during a designated utterance 116, or phonetic gesture, to achieve accuracy of pronunciation.

A very low normative average value 140, for example, a value 140 between 0 and 0.1, indicates that the associated one of sensors 30 is never contacted or rarely contacted during the ideal pronunciation of designated utterance 116. Sensors 30 having low normative average values 140 and/or low standard deviations 142 are referred to herein as critical non-contact sensors 146. Critical non-contact sensors 146 are those sensors 30 in which avoiding contact with these sensors 144 during a designated utterance 116, or phonetic gesture, is critical to achieve accuracy of pronunciation.

Conversely, a mid-range normative average value 140, for example, a value 140 greater than 0.1 and less than 0.9 indicates that the associated one of sensors 30 is not as critical to the ideal pronunciation of designated utterance 116. Sensors 30 having mid-range normative average values are referred to herein as neutral contact sensors 148. Neutral contact sensors 148 are those sensors 30 in which neither contact nor non-contact is critical and would likely have little effect on the pronunciation of designated utterance 116.

FIG. 7 shows a flowchart of a speech therapy process 150 in accordance with the present invention. Process 150 is performed in cooperation with the execution of speech analysis and visual feedback code 92 on computing system 24. Process 150 illustrates methodology for providing speech therapy to learner 76 who may be hearing impaired or a new language learner.

Process 150 begins with a task 152. At task 152, sensor plate 22′ (FIG. 1) custom-fit for learner 76 is placed in learner's mouth 74 and positioned against the palate of learner 76. Of course, other conventional tasks associated with the onset of speech therapy may additionally be performed, such as making learner 76 comfortable, initiating speech analysis and visual feedback code 92, connecting sensor plate 22′ to sensor input 78 (FIG. 3), and so forth.

Following task 152, learner 76 is instructed to speak a designated utterance 116 (FIG. 5) at a task 154. Again, designated utterance 116 may be a sound. Alternatively, designated utterance 116 may be a word, phrase or sentence containing a particular sound. Designated utterance 116 made by learner is detected by sensors 30 (FIG. 2) of sensor plate 22′ as a learner speech signal 156 (see FIG. 1). Learner speech signal 156 includes parameters identifying which of sensors 30 are contacted during designated utterance 116 made by learner 76.

In response to task 154, a task 158 is performed. At task 158, learner speech signal 156 is routed to computing system 24 (FIG. 3) where it is received at sensor input 78 (FIG. 3).

Following task 158, a task 160 is performed. At task 160, processor 80 ascertains a next set of learner contact indication signals from learner speech signal 156. Of course, during a first iteration of task 160, the “next” set of learner contact indication signals will be a first set.

A task 162 is performed in conjunction with task 160. At task 162, the current set of learner contact indication signals is at least temporarily saved in a memory component, such as memory 84 (FIG. 3). By way of illustration, another table 164 may retain a set of learner contact indication signals 166 as a series of affirmative contact signals 120 and negative contact signals 122, one each of which is associated with each of sensors 30.

Following task 162, a query task 168 determines whether designated utterance 116 (FIG. 5) is to be repeated by learner 76. When learner 76 is to repeat pronunciation of designated utterance 116, process control loops back to task 154 so that learner 76 repeats designated utterance 116 and another set of learner contact indication signals 166 is ascertained and saved. However, when a determination is made at query task 168 that there is to be no repetition of pronunciation of designated utterance by learner 76, speech therapy process 150 continues with a task 170.

Following the above described tasks, one or more sets of learner contact indication signals 166 are compiled from learner 76. The following tasks process the one or more sets of learner contact indication signals 166 to generate accuracy score 56 (FIG. 1) and to display accuracy score concurrently with an associated contact template 50 (FIG. 1) and learner contact pattern 52 (FIG. 1).

At task 170, an average value, vₛ, of affirmative contact is computed for each of sensors 30. For each sensor 30, the arithmetic mean, or the sum of occurrences of affirmative contact signal 120 divided by the total quantity of repetitions, i.e. total quantity of sets of learner contact indication signals 166, is computed. Thus, the average value, vₛ, of affirmative contact for each of sensors 30 indicates the point on a scale of measures where the quantity of affirmative contact signal 120 is centered.

Following task 170, a task 172 is performed. At task 172, a deviation measure is calculated for each of sensors 30. Referring to FIG. 8 in connection with task 172, FIG. 8 shows a table 174 of computations utilized within the process of FIG. 7. Table 174 includes a formula 176 for computing a deviation measure, DMₛ, 178 for each of sensors 30. As shown, formula 176 finds an absolute difference 179 between normative average value 140 and a corresponding learner average value 180. This difference is multiplied by an inverted standard deviation 182, i.e., one minus standard deviation 142, to establish a significance weight of the particular one of sensors 30. Formula 176 indicates that the smaller the standard deviation 142, the more significant that one of sensors 30 is to reproducing the ideal pronunciation of the designated utterance 116.

With continued reference to FIGS. 7-8, following calculation of deviation measure 178 for each of sensors 30 at task 172, a total deviation measure is calculated at a task 184. Table 174 includes a formula 186 for computing a total deviation measure, DM(T) 188 for each of sensors 30. As shown, formula 186 summates deviation measure 178 for each of sensors 30 calculated at task 172. Total deviation measure 188 characterizes an error of pronunciation of utterance 116 made by learner 76 (FIG. 1) relative to the ideal pronunciation of utterance 116 as modeled in contact template 50 (FIG. 1) specific to that utterance. Thus, a smaller total deviation measure 188 represents a closeness of learner pronunciation of utterance 116 relative to the ideal pronunciation. Whereas, a large total deviation measure 188 represents an inaccuracy of learner pronunciation of utterance 116 relative to the ideal pronunciation.

In response to task 184, accuracy score 56 is generated at a task 190. Table 174 includes a formula 192 that normalizes total deviation measure 188 to a percentage deviation measure, DM %, 194. Since total deviation measure 188, and consequently percentage deviation measure 194 is a measure of error, or difference between learner's pronunciation and the ideal pronunciation represented by contact template 50, another formula 196 converts the error, i.e., percentage deviation measure 194, to a quantified measure of accuracy, i.e., the difference between an ideal accuracy score 198, i.e., 100%, and percentage deviation measure 194.

In education, a grade, mark, or percentage is a quantified evaluation of a student's work. In grading systems, individuals are typically conditioned to recognize high marks or percentages as a higher, hence better, grade. The quantification of accuracy score 56 capitalizes on this educational conditioning by providing an easily understood numerical value of learner's closeness of pronunciation of designated utterance 116 to an ideal pronunciation of utterance 116. That is, the higher accuracy score 56 is to one hundred the closer the learner's pronunciation of utterance 116 to the ideal pronunciation.

Following generation of accuracy score 56 at task 190, speech therapy process 150 continues with a task 200. At task 200, contact template 50, learner contact pattern 52, and accuracy score 56 are provided to learner 76 via, for example, display 34 (FIG. 1). Alternatively, or in addition, contact template 50, learner contact pattern 52, and accuracy score 56 can be provided to learner 76 as a hard copy and/or can be stored in memory 84 (FIG. 3) of computing system 24 (FIG. 3) for later perusal.

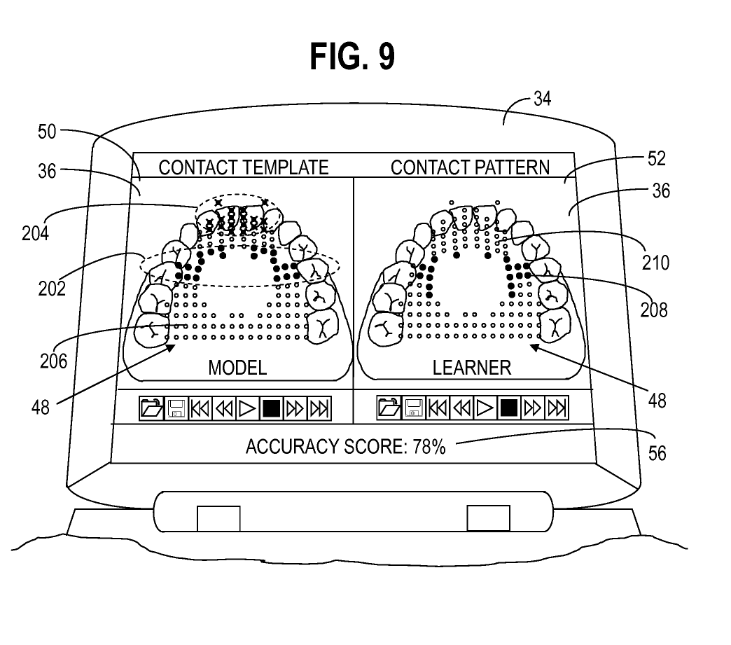

Referring to FIG. 9 in connection with task 200, FIG. 9 shows an illustration of display 34 of computing system 24. Display 34 includes split screen 36 with contact template 50, learner contact pattern 52, and accuracy score 56.

Contact template 50 includes grid of dots 48 in which a first portion of dots 48, representing critical contact sensors 144 (FIG. 6), are illustrated as enlarged dark circles. The enlarged dark circles represent an affirmative contact location 202 between a model tongue and a model palate. A second portion of dots 48, representing critical non-contact sensors 146 (FIG. 6), are illustrated by X's. The X's represent a negative contact location 204 between a model tongue and a model palate. The remaining dots 48, representing neutral contact sensors 148, form a neutral contact location 206 of the model tongue and the model palate.

Affirmative contact location 202 provides a visual indication to learner 76 (FIG. 1) of those areas of the learner's palate that should ideally be contacted by the learner's tongue during pronunciation of utterance 116 (FIG. 5). Likewise, negative contact location 204 provides a visual indication to learner 76 of those areas of the learner's palate that should ideally not be contacted by the learner's tongue during pronunciation of utterance 116. Neutral contact location provides a visual indication to learner 76 of the areas of the learner's palate at which contact or non-contact with the learner's tongue will have little or no effect on the pronunciation of utterance 116. Thus, affirmative contact location 202, negative contact location 204, and neutral contact location 206 are readily distinguishable from one another.

Enlarged dark circles, X's, and small circles are shown to distinguish affirmative contact location 202, negative contact location 204, and neutral contact location 206 within the line drawing of FIG. 9. In an actual clinical setting, green circles may be substituted for the enlarged dark circles and red circles may be substituted for the X's shown in FIG. 9. In addition, yellow circles may be substituted for the small circles shown in FIG. 9. The presentation of green, red, and yellow readily alerts most learners to affirmative contact, negative contact, or neutral contact locations due to most individuals' familiarity with the universal color code of a typical three color traffic light, or traffic signal.

Although three categories of linguapalatal contact criticality are discussed above (critical contact, critical non-contact, and neutral contact), those skilled in the art will recognize that locations may be defined in more or less categories in accordance with any desired breakdown of normative average values 140 and/or standard deviations 142 for sensors 30 shown in table 136 (FIG. 6). In addition, any variety of symbols and/or color codes may be utilized to distinguish the various locations in contact template 50.

Learner contact pattern 52 shown in FIG. 9 includes grid of dots 48 in which a first portion of dots 48, representing affirmative contact signals 120 (FIG. 7) from set of learner contact indication signals 166 (FIG. 7), are illustrated as enlarged dark circles. The enlarged dark circles represent an actual affirmative contact location 208 between a learner tongue and a learner palate. A second portion of dots 48, representing negative contact signals 122 (FIG. 7) from set of learner contact indication signals 166, are illustrated by small circles. The small circles represent an actual negative contact location 210 between a model tongue and a model palate. Provision of learner contact pattern 52 give learner 76 (FIG. 3) immediate feedback as to his or her linguapalatal contact during the pronunciation of designated utterance 116. Thus, learner 76 can directly compare learner contact pattern 52 with contact template 50.

In addition, accuracy score 56, shown in FIG. 9 as being 78% provides learner 76 with a readily understandable measure of the accuracy of his or her pronunciation of designated utterance 116, relative to an ideal pronunciation.

Returning to FIG. 8, following the display of contact template 50, learner contact pattern 52, and accuracy score 56 at task 200, speech therapy process proceeds to a query task 212. At query task 212, a determination is made as to whether to continue the current speech therapy session. When speech therapy is to continue, process control loops back to task 154 so that another one or more learner speech signals 156 (FIG. 1) can be received and processed at computing system to generate another value for accuracy score 56. Thus, learner 76 can practice his or her utterances with the object being to improve accuracy score 56, thereby more accurately pronounce designated utterance 116. When a determination is made at query task 212 to discontinue the current speech therapy session, process 150 exits.

In summary, the present invention teaches a method of providing speech therapy using a computing system executing voice analysis and visualization code. The methodology and code provide visualization of a learner's speech signals relative to a model pattern. In addition, a numerical accuracy score is provided to a learner. The numerical accuracy score is a readily understood quantification of an accuracy of the learner's speech pronunciation.

Although the preferred embodiments of the invention have been illustrated and described in detail, it will be readily apparent to those skilled in the art that various modifications may be made therein without departing from the spirit of the invention or from the scope of the appended claims. For example, the process steps discussed herein can take on great number of variations and can be performed in a differing order then that which was presented.

What is claimed is:

1. A method for providing speech therapy to a learner comprising:
receiving a speech signal from said learner at an input of a computing system, said speech signal corresponding to a designated utterance made by said learner;
ascertaining from said speech signal a set of parameters representing a contact pattern between a tongue and a palate of said learner during said utterance;
for each said parameter of said set of parameters, calculating a deviation measure relative to a corresponding parameter from a set of normative parameters characterizing an ideal pronunciation of said utterance, said set of normative parameters representing a contact template between a model tongue and a model palate;
generating, from said deviation measure, an accuracy score for said designated utterance relative to said ideal pronunciation of said utterance; and
providing said accuracy score to said learner to visualize an accuracy of said utterance relative to said ideal pronunciation of said utterance.

2. A method as claimed in claim 1 further comprising:
positioning a sensor plate against said palate of said learner, said sensor plate including a plurality of sensors disposed on said sensor plate; and
from each of said sensors, producing one of said parameters during said utterance, said one parameter being a contact indication signal of said tongue of said learner to said each sensor during said utterance.

3. A method as claimed in claim 2 further comprising:
repeating said receiving and ascertaining operations to obtain multiple ones of said contact indication signal for said each sensor during repeated occurrences of said utterance;
for said each sensor, computing an average value of affirmative contact of said tongue to said each sensor from said multiple ones of said contact indication signal; and
utilizing said average value of said affirmative contact as said each parameter of said set of parameters to calculate said deviation measure relative to said corresponding parameter from said set of normative parameters, said corresponding parameter being a normative average value of said affirmative contact.

4. A method as claimed in claim 1 further comprising for said each parameter, weighting said deviation measure according to a significance of said corresponding normative parameter.

5. A method as claimed in claim 1 further comprising:
positioning a sensor plate against said model palate of a model, said sensor plate including a plurality of sensors disposed on said sensor plate;
receiving a normative speech signal from said model, said normative speech signal corresponding to said ideal pronunciation of said utterance;
producing from each of said sensors one of said normative parameters during said ideal pronunciation of said utterance, said one normative parameter being a normative contact indication signal of said model tongue to said each sensor during said utterance; and
compiling each said contact indication signal for said each of said sensors to form said set of normative parameters of said contact template.

6. A method as claimed in claim 5 further comprising:
obtaining multiple ones of said normative contact indication signal for said each sensor during repeated occurrences of said utterance by said model;
computing a normative average value of affirmative contact of said model tongue with said each sensor from said multiple ones of said normative contact indication signal; and
utilizing said normative average value as said one of said normative parameters to calculate said deviation measure for said each of said set of parameters.

7. A method as claimed in claim 6 further comprising:
for said each sensor, establishing a significance value of said normative average value; and
weighting said deviation measure by said significance value.

8. A method as claimed in claim 1 further comprising:
combining said deviation measure for said each parameter of said set of parameters to form a total deviation measure characterizing an error of pronunciation of said utterance made by said learner relative to said ideal pronunciation of said utterance; and
utilizing said total deviation measure to generate said accuracy score as a difference between an ideal accuracy score and said total deviation measure.

9. A method as claimed in claim 1 further comprising:
displaying said contact template as a first grid of dots;
displaying said contact pattern as a second grid of dots, said contact pattern being displayed concurrently with contact template.

10. A method as claimed in claim 9 further comprising displaying said accuracy score concurrently with said contact template and said contact pattern.

11. A method as claimed in claim 9 wherein displaying said contact template comprises:
identifying a first subset of said corresponding parameters from said set of normative parameters that represent a critical contact location between said model tongue and said model palate;
identifying a second subset of said corresponding parameters from said set of normative parameters that represent a critical non-contact location between said model tongue and said model palate; and
distinguishing a first portion of said first grid of dots representing said critical contact location from a second portion of said first grid of dots representing said critical non-contact location in said displayed contact template.

12. A method as claimed in claim 11 further comprising:
identifying a third subset of said corresponding parameters from said set of normative parameters that represent a neutral contact location between said model tongue and said model palate; and
distinguishing a third portion of said first grid of dots representing said neutral contact location from each of said first and second portions.

13. A method as claimed in claim 9 wherein displaying said contact pattern comprises:
identifying a first subset of said parameters from said set of parameters that represent an affirmative contact location between said tongue and said palate of said learner;
identifying a second subset of said parameters from said set of parameters that represent a negative contact location between said tongue and said palate of said learner; and
distinguishing a first portion of said second grid of dots representing said affirmative contact location from a second portion of said second grid of dots representing said negative contact location in said displayed contact pattern.

14. A computer-readable storage medium containing a computer program for providing speech therapy to a learner comprising:
a database including a plurality of contact templates, each of said contact templates including a set of normative parameters characterizing an ideal pronunciation of one of a plurality of utterances, said set of normative parameters being formed in response to contact between a model tongue and a model palate during said ideal pronunciation of said one of said plurality of utterances; and
executable code for instructing a processor to quantify an accuracy of a designated utterance produced by said learner, said executable code instructing said processor to perform operations comprising:
receiving a speech signal from said learner, said speech signal corresponding to said designated utterance made by said learner;
ascertaining from said speech signal a set of parameters representing a contact pattern between a tongue and a palate of said learner during said utterance;
for each said parameter of said set of parameters, calculating a deviation measure relative to a corresponding parameter from said set of normative parameters for one of said contact templates associated with said designated utterance in said database;
combining said deviation measure for said each parameter of said set of parameters to form a total deviation measure characterizing an error of pronunciation of said utterance made by said learner relative to said ideal pronunciation of said utterance;
generating an accuracy score for said designated utterance relative to said ideal pronunciation of said utterance, said generating operation utilizing said total deviation measure to generate said accuracy score as a difference between an ideal accuracy score and said total deviation measure; and
providing said accuracy score to said learner to visualize an accuracy of said utterance relative to said ideal pronunciation of said utterance.

15. A computer-readable storage medium as claimed in claim 14 wherein a sensor plate is positioned against said palate of said learner, said sensor plate including a plurality of sensors disposed on said sensor plate, each of said sensors producing one of said parameters during said utterance, said one parameter being a contact indication signal of said tongue of said learner to said each sensor during said utterance, and:
said database includes normative average values of affirmative contact of said model tongue to said sensors disposed on said sensor plate worn by a model, each of said normative parameters being one of said normative average values for one of said sensors; and
said executable code instructs said processor to perform further operations comprising:
repeating said receiving and ascertaining operations to obtain multiple ones of said contact indication signal for said each sensor during repeated occurrences of said utterance;
for said each sensor, computing an average value of affirmative contact of said tongue to said each sensor from said multiple ones of said contact indication signal; and
utilizing said average value of affirmative contact to calculate said deviation measure for said each sensor relative t one of said normative average values for said each sensor.

16. A computer-readable storage medium as claimed in claim 15 wherein:
said database includes a significance value established for each of said normative average values for said each of said sensors; and
said executable code instructs said processor to perform a further operation comprising weighting said deviation measure for said each parameter according to said significance value of said each of said normative average values.

17. A system for providing speech therapy to a learner, said system comprising:
a sensor plate positioned against a palate of said learner, said sensor plate including a plurality of sensors disposed on said sensor plate, and each of said sensors producing a contact indication signal of said tongue of said learner to said each of said sensors during a designated utterance made by said learner;
a processor having an input in communication with said sensor plate for receiving a speech signal from said learner corresponding to said designated utterance, said processor performing operations comprising:
ascertaining from said speech signal, said contact indication signal from said each of said sensors;
for each said contact indication signal, calculating a deviation measure relative to a corresponding normative contact indication signal from a set of normative parameters characterizing an ideal pronunciation of said utterance; and
generating, from said deviation measure, an accuracy score for said designated utterance relative to said ideal pronunciation of said utterance; and
a display in communication with said processor for providing said accuracy score to said learner to visualize an accuracy of said utterance relative to said ideal pronunciation of said utterance.

18. A system as claimed in claim 17 wherein said display further concurrently displays said contact template as a first grid of dots and said contact pattern as a second grid of dots with said accuracy score.

19. A system as claimed in claim 18 wherein said contact template distinguishes a first portion of said first grid of dots from a second portion of said first grid of dots, said first portion representing a critical contact location between said model tongue and said model palate and said second portion representing a critical non-contact location between said model tongue and said model palate.

20. A system as claimed in claim 19 wherein said contact template distinguishes a third portion of said first grid of dots from said first and second portions, said third portion representing a neutral contact location between said model tongue and said model mouth.
